(19) United States
(12) Patent Application Publication
(10) Pub. No.: US 2003/0184745 A1
(43) Pub. Date: Oct. 2, 2003

(54) Positioning device for microtiter plates

(76) Inventors: Holger Deppe, Frankfurt (DE); G?uuml;nter Brenner, Griesheim (DE); Michael Schmelz, Griesheim (DE); Thomas Dietrich, Frankfurt (DE); Dagmar Vogel, Mainz (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/362,992

(22) PCT Filed: Aug. 3, 2001
(86) PCT No.: PCT/EP01/08997

(30) Foreign Application Priority Data
Sep. 1, 2000 (DE) 10042999.8

(51) Int. Cl. G01N 21/01

(52) U.S. Cl. 356/244

(57) ABSTRACT

A positioning device for glass microtiter plates (3) has a holding frame (1) with a support surface (2). Once introduced, the microtiter plate (3) is held in the position provided for it in the holding frame (1) by spring-like snap-in pins (5). Inwardly protruding projections (6) prevent the microtiter plate (3) from accidentally falling out of the holding frame (1). A continuous recess (7) in the area of the support surface (2) enables the microtiter plate (3) to be observed freely from both sides.

The invention relates to a positioning device for microtitre plates made of glass.

Both in the area of research and development and in diagnostics, the need for chemical or biological samples to be analysed is increasingly continuously. For the constantly improved assay methods, the amount of sample and assay substance required are at the same time becoming ever smaller. Especially in the area of chemical analysis, it is therefore being attempted to analyse ever-increasing numbers and ever-smaller amounts of samples in parallel and in the most automated manner possible. A whole series of automated analytical instruments has therefore been developed, international standards having been laid down for the dimensions of the sample containers that are compatible therewith. In this way, it has been achieved that, as part of an analysis, various steps can be carried out with in each case the optimum analytical instrument for this step without the sample container having to be changed.

The sample containers usually used as part of such analyses consist of a large number of small microreactors, which are arranged in the form of a rectangular, flat plate. For economic and manufacturing reasons, sample containers of this type are predominantly made of plastic.

For some analyses, however, for example with aggressive reagents or organic solvents, high chemical resistance of the sample containers is necessary. Since such analyses cannot be carried out with sample containers made of plastic, in this case, for example, so-called microtitre plates made of glass are used. These microtitre plates may consist of a special glass sheet into which a large number of cavities have been etched by a photochemical process. However, the production of a photostructured special glass plate which corresponds to the external dimensions of the international standard prescribed for use in automated analytical instruments is difficult to achieve for technical reasons.

In contrast to sample containers made of plastic, microtitre plates made of glass are relatively susceptible to mechanical stresses, as may occur, for example, during use in an automated analytical instrument or during transport within the laboratory rooms. For economic reasons, such microtitre plates made of glass are frequently used a number of times. High mechanical stresses occur then and especially during cleaning of microtitre plates made of glass which have already been used.

The object of the invention is accordingly to design a positioning device for the accommodation of microtitre plates made of glass in such a way that precise positioning of the microtitre plates made of glass is possible for use in automated analytical instruments, that the inserted microtitre plate is adequately protected against mechanical damage, and easy insertion and removal of the microtitre plate is possible even without an additional tool.

The solution to this object in accordance with the invention is based on a positioning device for microtitre plates made of glass having a retaining frame, having a support surface for the accommodation of the microtitre plate which is at least partially surrounded by lateral elevations, and having spring elements which press against the microtitre plate.

The microtitre plate made from glass inserted into the retaining frame lies securely on the support surface provided for this purpose. The spring elements position the microtitre plate reproducibly and sufficiently firmly within the retaining frame. The lateral elevations of the retaining frame, which surround the inserted microtitre plate, protect the latter against mechanical damage, especially at its edges. The external dimensions of the positioning device are advantageously matched to the specifications in the international standard, enabling problem-free use of the positioning device in automated analytical instruments. By contrast, the dimensions of the support surface can be freely selected, enabling even significantly smaller and thus significantly less expensive microtitre plates to be used for the automated analytical method.

According to an advantageous embodiment of the inventive idea, it is proposed that the retaining frame has inward-pointing projections above the support surface of the microtitre plate. These inward-pointing projections above the support surface encompass the inserted microtitre plate and thus prevent it from unintentionally falling out.

It is preferably provided that the spring elements are in the form of sprung snap-in pins. The pressing spring elements hold the microtitre plate firmly in the proposed position in the retaining frame merely through the non-positive connection. The spring elements in the form of snap-in pins encompass the inserted microtitre plate and thus prevent the latter from sliding in an undesired manner, even in the case of relatively large loading, such as, for example, in the case of unintentional impacts. This snap-in encompassing of the microtitre plate by spring elements in the form of snap-in pins can easily be released again by pushing the pin elements away to the side and removing the microtitre plate.

According to an embodiment of the inventive idea, it is proposed that the retaining frame has a continuous recess in the region of the support surface. Many reactions can be evaluated relatively simply, for example, with reference to discoloration that has taken place in the sample material. An evaluation of this type is significantly simplified since, as a consequence of the recess, the microtitre plate can be viewed freely from both sides and simple, automatable evaluation methods, such as, for example, transmitted-light measurements, can be used.

It is advantageously provided that the positioning device essentially consists of plastic or a metal. Manufacture can then take place preferably as an inexpensive injection moulding from various commercially available plastics, corresponding to the chemical requirements. A retaining frame made of plastic does not cause any traces of wear on the inserted microtitre plate, owing to its significantly lower hardness.

An illustrative embodiment of the invention is explained in greater detail below and is shown in the drawing, in which:

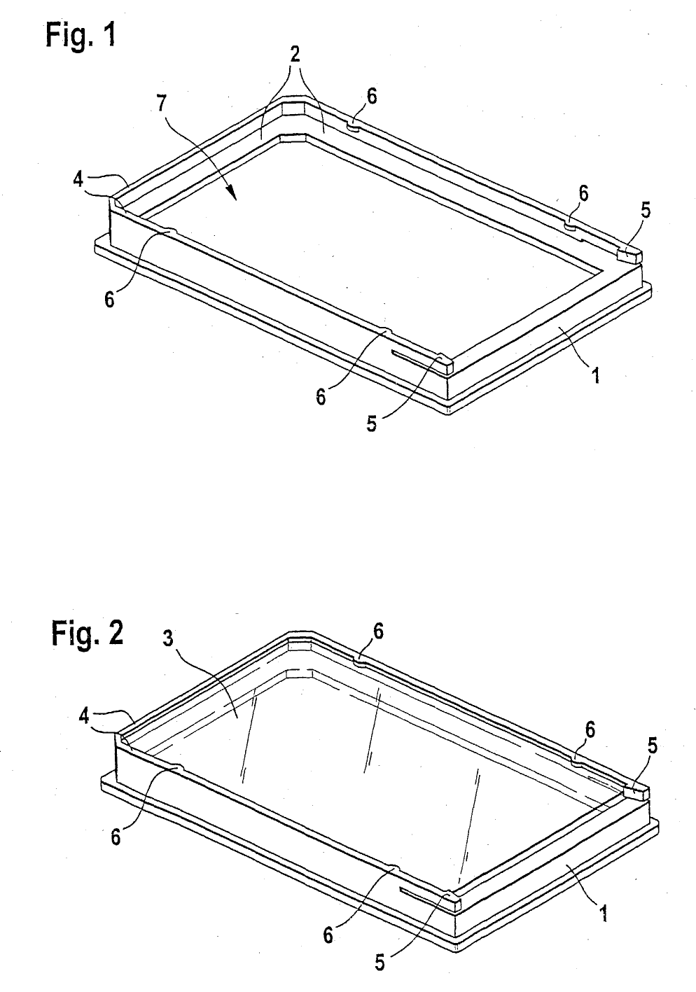

FIG. 1 shows a view of the positioning device, and

FIG. 2 shows a view of the positioning device with inserted microtitre plate.

The positioning device shown in both figures has an essentially rectangular, planar retaining frame 1. The retaining frame 1 has a support surface 2. This support surface 2, which is provided for the accommodation of a microtitre plate 3 made of glass, is delimited on three sides by lateral elevations 4 of the retaining frame 1. On the fourth side, a short end side in the illustrative embodiment shown, the support surface 2 is not delimited by a lateral elevation 4. The microtitre plate 4 can be pushed laterally onto the support surface 2 from this side like a drawer.

Towards the open side of the support surface 2, the lateral elevations 4 are in the form of sprung snap-in pins 5. These are easily bent back during insertion of the microtitre plate 3 and lock in when the microtitre plate 3 has reached the proposed position on the support surface 2. The sprung snap-in pins 5 prevent the microtitre plate 3 made of glass from unintentionally sliding in the retaining frame 1. The microtitre plate 3 is released by slightly bending the sprung snap-in pins 5 to the side and can easily be removed again.

On the long sides of the retaining frame 1, inward-pointing projections 6 are formed at the lateral elevations 4 above the support surface 2. These projections serve for improved guiding of the microtitre plate 3 during insertion into the retaining frame 1 and prevent the microtitre plate 3 from unintentionally falling out.

The retaining frame 1 has a continuous recess 7 in the region of the support surface 2. The dimensions of the recess 7 are smaller than those of the microtitre plate 3, so that the remaining support surface 2 thereby essentially forms a circumferential frame. Although the microtitre plate 3 lies securely on the support surface 2, designed as a circumferential frame, the individual reaction cavities can be viewed freely from both sides and are accessible to automatic evaluation methods.

The positioning device can be manufactured inexpensively from commercially available plastics as a one-part injection moulding. For special applications, however, manufacture from high-quality speciality plastics by machining is also conceivable.

1. Positioning device for microtitre plates (3) made of glass, having a retaining frame (1), having a support surface (2) for the accommodation of the microtitre plate (3) which is at least partially surrounded by lateral elevations (4), and having spring elements (5) which press against the microtitre plate (3).

2. Positioning device according to claim 1, characterised in that the retaining frame (1) has inward-pointing projections (6) above the support surface (2) for the microtitre plate (3).

3. Positioning device according to claim 1, characterised in that the spring elements are in the form of sprung snap-in pins (5).

4. Positioning device according to claim 1, characterised in that the retaining frame (1) has a continuous recess (7) in the region of the support surface (2).

5. Positioning device according to claim 1, characterised in that the positioning device essentially consists of plastic or a metal.
